(19) United States
(12) Patent Application Publication
(10) Pub. No.: US 2022/0172228 A1
(43) Pub. Date: Jun. 2, 2022

(54) SALES MANAGEMENT SYSTEM, STORE APPARATUS, SALES MANAGEMENT METHOD, AND PROGRAM

(71) Applicant: NEC Corporation, Minato-ku, Tokyo (JP)

(72) Inventors: Soma SHIRAISHI, Tokyo (JP); Kota IWAMOTO, Tokyo (JP); Shinya YAMASAKI, Tokyo (JP)

(73) Assignee: NEC Corporation, Minato-ku, Tokyo (JP)

(21) Appl. No.: 17/441,334

(22) PCT Filed: Mar. 29, 2019
(86) PCT No.: PCT/JP2019/014184

§ 371 Date: Sep. 21, 2021

(51) Int. Cl. G06Q 30/02; G06V 20/60

(52) U.S. Cl. CPC G06Q 30/0201; G06V 20/60

(57) ABSTRACT

A sales management system (1) is configured to include an image processing unit (110) and an output unit (130). The image processing unit (110) identifies, based on an image of a purchase product, the product and a package design of the product. The output unit (130) outputs sales performance information by package design of the product, based on an identification result of the product and the package design of the product.

### TECHNICAL FIELD

The present invention relates to a product analysis technique.

### BACKGROUND ART

One example of a technique for marketing is disclosed in PTL 1 described below, for example. PTL 1 discloses a technique for acquiring various pieces of information for each package design by setting, foe each package design, a different shape of a symbol row of a bar code when a plurality of package designs are present for the same product.

### CITATION LIST

### Patent Literature

[PTL 1] Japanese Patent Application Publication No. 2014-006651

### SUMMARY OF INVENTION

### Technical Problem

A package design of a product is one of main elements that affect a purchase intention of a customer. There may be a significant difference in sales due to a difference in package design even between products having the same content. When sales performance by package design of a product is clear, sales of the product can be further improved.

The present invention has been made in view of the above-described problem. One of objects of the present invention is to provide a technique for being able to acquire information indicating sales performance by package design of a product.

### Solution to Problem

A sales management system according to the present invention, including:

an image processing unit that identifies, based on an image of a purchase product, the product and a package design of the product; and

an output unit that outputs sales performance information by package design of the product, based on an identification result of the product and the package design of the product.

A sales management method according to the present invention, including:

by a computer,

identifying, based on an image of a purchase product, the product and a package design of the product; and

outputting sales performance information by package design of the product, based on an identification result of the product and the package design of the product.

A program according to the present invention for causing a computer to function as:

a unit that identifies, based on an image of a purchase product, the product and a package design of the product; and

a unit that outputs sales performance information by package design of the product, based on an identification result of the product and the package design of the product.

A store apparatus according to the present invention, including:

an acquisition unit that acquires an identification result of a product and a package design of the product; and

an unit that outputs sales performance information by package design of the product, based on an identification result of the product and the package design of the product.

### Advantageous Effects of Invention

The present invention is able to acquire information indicating sales performance by package design of a product.

### BRIEF DESCRIPTION OF DRAWINGS

The above-described object, the other objects, features, and advantages will become more apparent from suitable example embodiments described below and the following accompanying drawings.

FIG. 1 is a diagram illustrating a functional configuration of a sales management system according to a first example embodiment.

FIG. 2 is a diagram illustrating a specific configuration of the sales management system according to the first example embodiment.

FIG. 3 is a diagram illustrating a hardware configuration of a store apparatus constituting the sales management system.

FIG. 4 is a sequence diagram illustrating a flow of identification result accumulation processing performed by the sales management system according to the first example embodiment.

FIG. 5 is a diagram illustrating one example of a feature data storage unit that stores feature data for each package design of a product, in association with product identification information that identifies the product.

FIG. 6 is a diagram for describing one example of an operation of an image processing unit.

FIG. 7 is a flowchart illustrating a flow of sales performance information output processing performed by the sales management system according to the first example embodiment.

FIG. 8 is a diagram illustrating one example of sales performance information by package design of a product being output from an output unit.

FIG. 9 is a diagram illustrating a functional configuration of a sales management system according to a second example embodiment.

FIG. 10 is a flowchart illustrating a flow of identification result accumulation processing performed by the sales management system according to the second example embodiment.

### EXAMPLE EMBODIMENT

Hereinafter, example embodiments of the present invention will be described by using drawings. Note that, in all of the drawings, a similar component has a similar reference sign, and description thereof will not be repeated as appropriate. Further, in each block diagram, each block represents a configuration of a functional unit instead of a configuration of a hardware unit unless otherwise described. Further, a direction of an arrow in the drawings is used for facilitating understanding of a flow of information, and does not limit a direction (one-way communication/two-way communication) of communication unless otherwise described.

### First Example Embodiment

### Functional Configuration Example

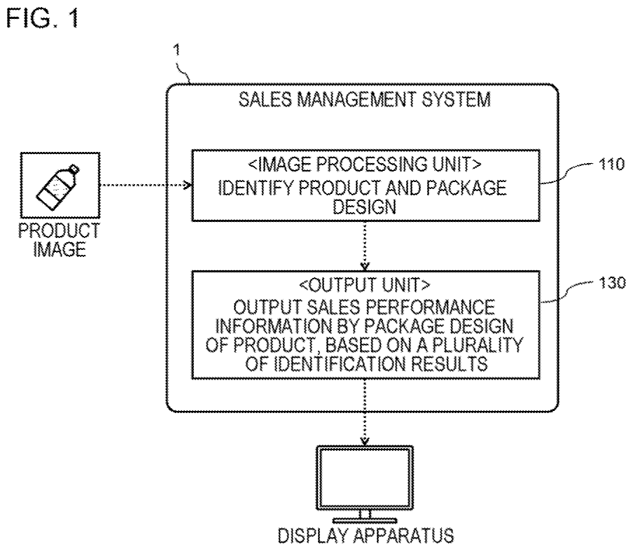

FIG. 1 is a diagram illustrating a functional configuration of a sales management system 1 according to a first example embodiment. As illustrated in FIG. 1, the sales management system 1 is configured to include an image processing unit 110 and an output unit 130.

The image processing unit 110 identifies a product (purchase product) to be purchased by a customer and a package design of the product, based on an image of the product. Herein, the “package design of a product” includes, for example, an appearance feature of a product itself such as a picture, an illustration, a character, a product logo, and other decoration being printed on a surface portion or a label of the product. Further, the “package design of a product” may include an appearance feature of an object (for example, a point of purchase (POP) sticker affixed to a product, and the like) being separately provided to a product in addition to the appearance feature of a product itself exemplified above. The image processing unit 110 is configured to be able to identify a product captured in an image and a package design of the product by using an existing image recognition algorithm. The output unit 130 generates and outputs sales performance information by package design of a product, based on an image processing result (an identification result of a product and a package design of the product) of the image processing unit 110. For example, the output unit 130 can aggregate, by package design, a sales total number, a sales amount, and the like of a product in a predetermined period, based on a plurality of image processing results, and output the aggregate result as sales performance information to a display apparatus and the like.

Each of the functional units (the image processing unit 110 and the output unit 130) described above is stored as a program module in a storage device and the like of at least one computer. Then, a processor installed in the computer reads and executes the program module, and thus a function associated with each module is achieved.

### Action and Effect

In the sales management system 1 according to the present example embodiment, by first processing an image of a product (purchase product) to be purchased by a customer, an identification result of the product and an identification result of a package design of the product are generated. An identification result of a product and a package design of the product is generated and accumulated every time a product is purchased. Then, sales performance information indicating sales performance by package design of a product is generated based on accumulated identification results (identification results of the product and a package design of the product). For example, when one certain product is available with a plurality of package designs, sales performance information indicating sales performance (a sales total number, a sales amount, and the like) of each current package design is generated from identification results (identification results of a product and a package design of the product) being accumulated by the sales management system 1 according to the present example embodiment. Such sales performance information is information useful to a product analysis.

As one example, sales performance information acquired in the sales management system 1 according to the present example embodiment becomes information useful to an ordering operation of a product. For example, a person in charge of an ordering operation can determine, based on sales performance information indicating sales performance by package design, how to decide an order number for each package design of a product available with a plurality of package designs in order to be able to expect an improvement in sales.

In addition, when a package design of a product changes, the sales management system 1 according to the present example embodiment is able to acquire sales performance information indicating a difference in sales performance between new and old package designs. Sales performance information indicating a difference in sales performance between current package designs, a difference in sales performance between new and old package designs, and the like becomes information useful to a manufacturer of the product when an effect of a package design is measured. A store using the sales management system 1 can also utilize sales performance information as information provided to a product manufacturer. For example, a utilization method of transmitting (or selling), from a store using the sales management system 1 to a manufacturer, information indicating sales performance by package design of a product manufactured by the manufacturer is conceivable.

### Specific Example

Hereinafter, a more specific configuration is illustrated for describing the sales management system 1 according to the present example embodiment.

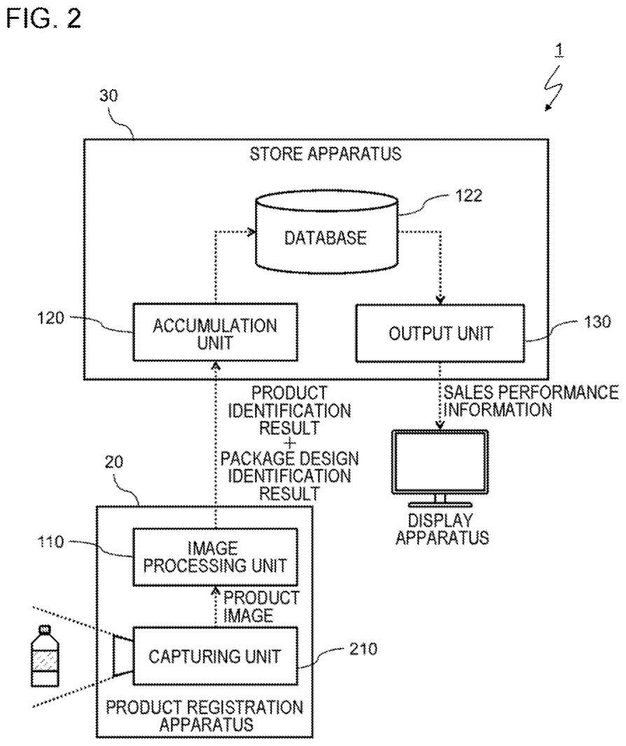

FIG. 2 is a diagram illustrating a specific configuration of the sales management system 1 according to the first example embodiment. The sales management system 1 illustrated in FIG. 2 is configured to include a store apparatus 30 and a product registration apparatus 20. Note that, although omitted for simplifying the drawing, a plurality of the product registration apparatuses 20 may be present in the sales management system 1.

The store apparatus 30 is, for example, a salesclerk terminal used for an management operation (such as ordering of a product) at a store by a salesclerk. The product registration apparatus 20 is a so-called register terminal at least including a function of registering a product to be purchased by a customer. The product registration apparatus 20 is also one element constituting a checkout processing system at a store.

Herein, the checkout processing system at a store can be broadly divided into three following kinds. The first one is a conventional system for performing, by an apparatus operated by a salesclerk, registration of a product (product to be purchased by a customer) to be checked out and payment of a price. The second one is a system (which may be referred to as a “semi-self type”) for performing registration of a product to be checked out by a first apparatus operated by a salesclerk, and performing payment of a price by a second apparatus operated by a customer. The third one is a system (which may be referred to as a “self type”) for performing, by an apparatus operated by a customer, registration of a product to be checked out and payment of a price. The product registration apparatus 20 illustrated in FIG. 2 is an apparatus operated by a salesclerk in the first and second systems described above, and is an apparatus operated by a customer in the third system described above. In addition, there is also a method of registering a product held by a customer by using a camera installed in a store without using a register terminal. In this case, a server apparatus that processes an image of the camera installed in the store, and recognizes and registers a product corresponds to the product registration apparatus 20. Further, there is also a method of causing a portable terminal of a customer to function as an apparatus for product registration by installing a specialized application in the portable terminal. In this case, a portable terminal of a customer (strictly speaking, an application installed in the portable terminal) corresponds to the product registration apparatus 20.

In the example in FIG. 2, the product registration apparatus 20 includes an image processing unit 110 and a capturing unit 210. The capturing unit 210 is a camera module formed of a lens, a capturing element, a signal processing substrate, and the like, and generates an image of a product to be purchased by a customer. Note that, although not illustrated, the product registration apparatus 20 further includes another functional processing unit used in an checkout operation. Further, in the example in FIG. 2, the store apparatus 30 includes an accumulation unit 120, a database 122, and an output unit 130. The database 122 stores an image processing result (an identification result of a product and a package design of the product) by the image processing unit 110. In the example in FIG. 2, the accumulation unit 120 has a function as a processing unit that acquires an image processing result from the image processing unit 110. The accumulation unit 120 accumulates, in the database 122 (predetermined storage region), an image processing result acquired from the image processing unit 110. Note that, the database 122 may be provided in an external apparatus (not illustrated) communicably connected to the store apparatus 30.

### Hardware Configuration Example

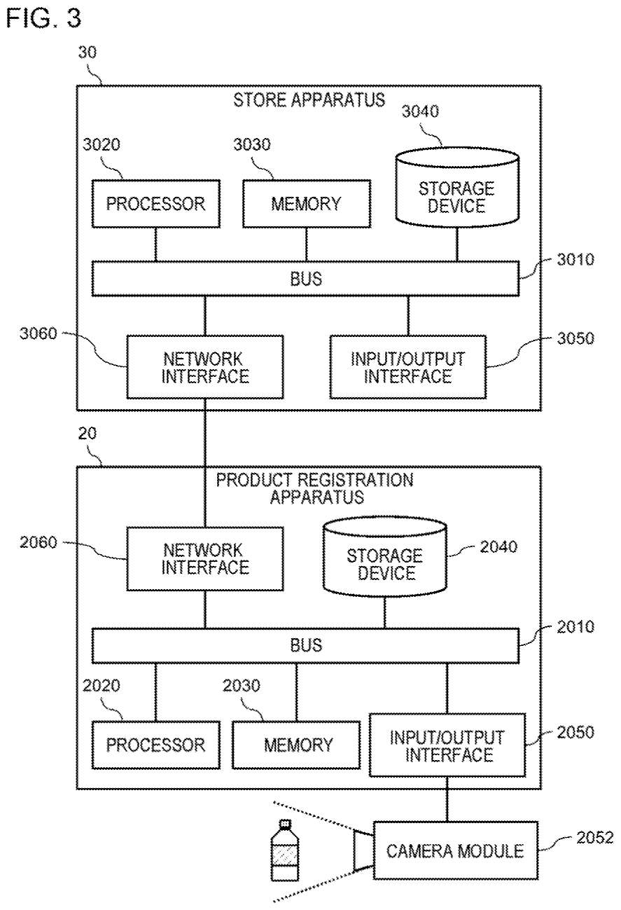

FIG. 3 is a diagram illustrating a hardware configuration of the store apparatus 30 constituting the sales management system 1.

The product registration apparatus 20 includes a bus 2010, a processor 2020, a memory 2030, a storage device 2040, an input/output interface 2050, and a network interface 2060.

The bus 2010 is a data transmission path for allowing the processor 2020, the memory 2030, the storage device 2040, the input/output interface 2050, and the network interface 2060 to transmit and receive data with one another. However, a method of connecting the processor 2020 and the like to each other is not limited to bus connection.

The processor 2020 is a processor achieved by a central processing unit (CPU), a graphics processing unit (GPU), and the like.

The memory 2030 is a main storage achieved by a random access memory (RAM) and the like.

The storage device 2040 is an auxiliary storage achieved by a hard disk drive (HDD), a solid state drive (SSD), a memory card, a read only memory (ROM), or the like. The storage device 2040 stores a program module that achieves a function of the image processing unit 110 and another function for checkout processing. The processor 2020 reads the program module onto the memory 2030 and executes the program module, and thus the function of the image processing unit 110 described above and various functions for checkout processing are achieved.

The input/output interface 2050 is an interface for connecting the product registration apparatus 20 to a peripheral apparatus. A camera module 2052 (capturing unit 210) for generating a product image is connected to an input/output interface 1050. Further, although not illustrated, an input apparatus such as a keyboard and a mouse, an output apparatus such as a display (touch panel display) and a speaker, a peripheral apparatus for a register operation such as a bar code scanner, a receipt printer, a card reader/writer, a cash register, a drawer, and an automatic change machine are connected to the input/output interface 2050.

The network interface 2060 is an interface for connecting the product registration apparatus 20 to a network. The network is, for example, a local area network (LAN) and a wide area network (WAN). A method of connection to the network by the network interface 2060 may be wireless connection or wired connection. The product registration apparatus 20 is communicably connected to the sales management system 10 via the network interface 2060. The product registration apparatus 20 can transmit a processing result (an identification result of a product and an identification result of a package design) of an image generated by the camera module 2052 (capturing unit 210) to the store apparatus 30 via a network interface 1060.

Similarly to the product registration apparatus 20, the store apparatus 30 also includes a bus 3010, a processor 3020, a memory 3030, a storage device 3040, an input/output interface 3050, and a network interface 3060. The storage device 3040 of the store apparatus 30 stores a program module that achieves each function (such as the accumulation unit 120 and the output unit 130) of the store apparatus 30. The processor 3020 reads each program module onto a memory 1030 and executes the program module, and thus the function of the accumulation unit 120 described above and the function of the output unit 130 are achieved. Further, the database 122 may be constructed on the storage device 3040.

Note that, the configuration illustrated in FIG. 3 is merely one example, and a configuration of hardware of the product registration apparatus 20 and the store apparatus 30 is not limited to the example in FIG. 3.

### Flow of Processing

Hereinafter, a flow of processing performed by the sales management system 1 according to the present example embodiment will be described. The processing performed in the sales management system 1 is divided into processing of accumulating, in the database 122, a result (an identification result of a product and a package design of the product) of processing an image of a product to be purchased, and processing of generating sales performance information by package design, based on information accumulated in the database 122.

### Identification Result Accumulation Processing

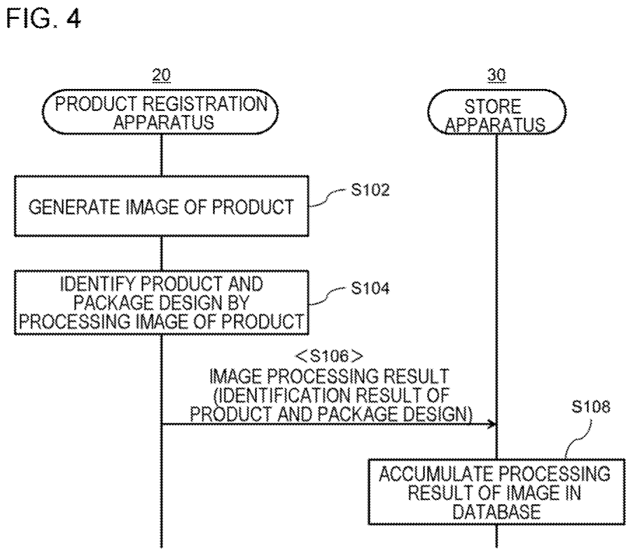

First, by using FIG. 4, a flow of processing (identification result accumulation processing) of accumulating an identification result of a product and a package design of the product in the database 122 will be described. FIG. 4 is a sequence diagram illustrating a flow of the identification result accumulation processing performed by the sales management system 1 according to the first example embodiment.

First, the capturing unit 210 generates an image of a product to be purchased by a customer (S102). The capturing unit 210 stores the generated image of the product in a storage region such as the memory 2030 and the storage device 2040. The image processing unit 110 identifies the product captured in the image and a package design of the product by processing the image of the product being generated in S102 (S104).

As one example, the image processing unit 110 may be configured in such a way as to identify a product captured in an image and a package design of the product by using a discriminator constructed to be able to identify a product and a package design by machine learning. As another example, the image processing unit 110 may be configured in such a way as to identify a product captured in an image and a package design of the product by verifying feature data being extractable from the image with feature data by package design of each product being previously registered.

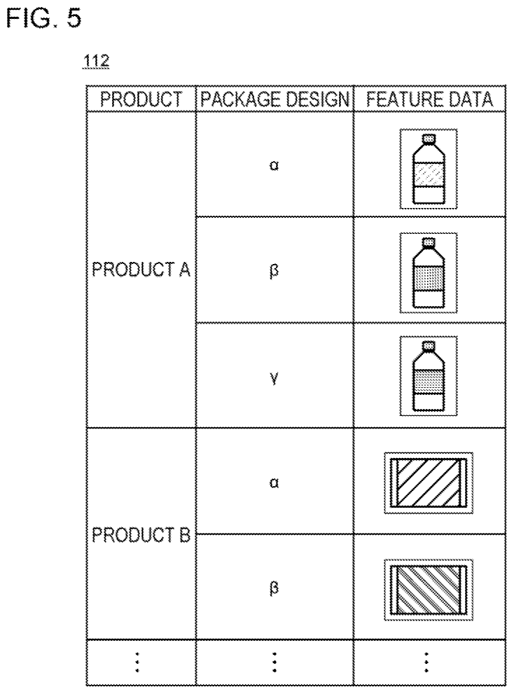

In a case of the latter configuration, for example, the image processing unit 110 can identify a product captured in an image and a package design of the product by using a table (feature data storage unit) that stores information as illustrated in FIG. 5. FIG. 5 is a diagram illustrating one example of a table (feature data storage unit 112) that stores feature data for each package design of a product, in association with product identification information that identifies the product. The table (feature data storage unit 112) illustrated in FIG. 5 stores a reference image (feature data) by package design in association with product identification information about each product. The table (feature data storage unit 112) illustrated in FIG. 5 may be provided in the product registration apparatus 20, and may be provided in an external apparatus (the store apparatus 30, and the like) being communicably connected to the product registration apparatus 20.

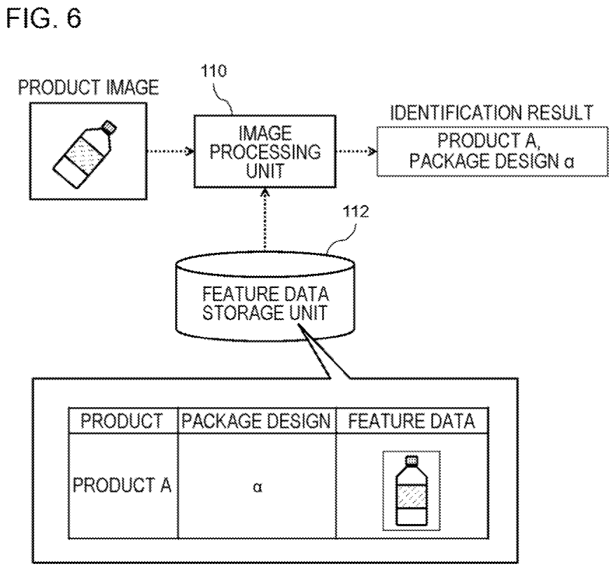

Herein, it is assumed that a product image as illustrated in FIG. 6 is acquired as an image to be processed. FIG. 6 is a diagram for describing one example of an operation of the image processing unit 110. In this case, the image processing unit 110 can acquire an identification result of “product A” and “package design a” from a verification result of feature data acquired from a processing target image in FIG. 6 with feature data for each package design of a product being stored in the table in FIG. 5.

Herein, there is also a case where product identification information (Japan article number (JAN)) of a product can be acquired, by infrared rays of the product registration apparatus 20 or an image scanner, from a code symbol (for example, a bar code in which JAN is encoded) provided to the product. In this case, the image processing unit 110 can narrow down, by using the acquired product identification information, data to be verified from feature data for each package design of a plurality of products being stored in a table. For example, when product identification information about “product A” can be acquired from the product registration apparatus 20, the image processing unit 110 can narrow down data to be verified to first to third rows of the table illustrated in FIG. 5. According to such a configuration, feature data about many products can be excluded from verification targets, and thus an effect of shortening processing time for identifying a package design of a product can be expected.

Referring back to FIG. 4, the image processing unit 110 transmits, to the store apparatus 30, a result (an identification result of a product and an identification result of a package design of the product) of processing an image of each product (S106). Note that, the image processing unit 110 may be configured in such a way as to accumulate a result of image processing in a storage region such as the memory 2030 until a product registration operation is completed in the product registration apparatus 20 (for example, a “subtotal” button or the like is pressed on a register operation screen), and collectively transmit, to the store apparatus 30, processing results accumulated in the storage region in a stage in which the product registration operation is completed.

The accumulation unit 120 accumulates, in the database 122, a processing result (an identification result of a product captured in an image and an identification result of a package design of the product) of an image by the image processing unit 110 (S108). In this way, information on which sales performance information by package design of a product is based is accumulated in the database 122.

### Sales Performance Information Output Processing

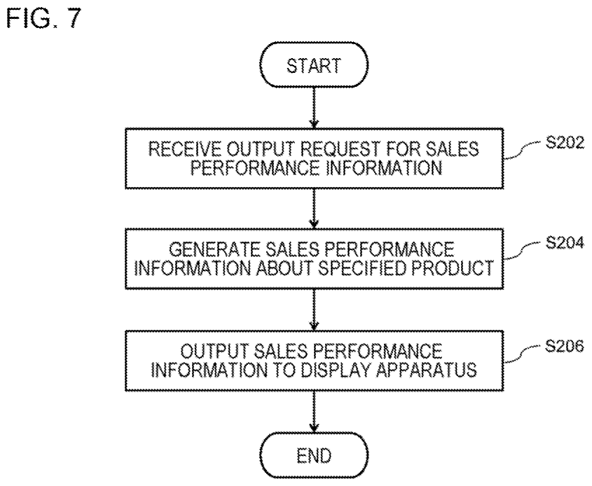

Next, by using FIG. 7, a flow of processing (sales performance information output processing) of outputting sales performance information by package design, based on information accumulated in the database 122, will be described. FIG. 7 is a flowchart illustrating the flow of the sales performance information output processing performed by the sales management system 1 according to the first example embodiment.

First, the output unit 130 receives an output request for sales performance information (S202). The output request includes information (for example, a product identification code and a product name of a product as a target, and the like) that specifies which sales performance information about a product is output. For example, a salesclerk in charge of an ordering operation inputs information (a product identification code, a product name, and the like) that specifies a product as a target by using an input apparatus connected to the input/output interface 2050 of the store apparatus 30. Further, a salesclerk in charge of an ordering operation may input information that specifies a product as a target by using a not-illustrated terminal (such as a tablet terminal) connected to the store apparatus 30 via the network interface 3060. The output unit 130 receives an output request including information (information that specifies a product as a target) being input in such a manner.

The output unit 130 generates, in response to the output request for sales performance information, sales performance information about a product specified by the output request (S204). The output unit 130 first reads, from the database 122, information related to a product (specified product) specified by the output request received in the processing in 5202. Then, the output unit 130 aggregates a sales total number, a sales amount, and the like by package design, based on the information about the specified product being read from the database 122, and generates sales performance information by package design.

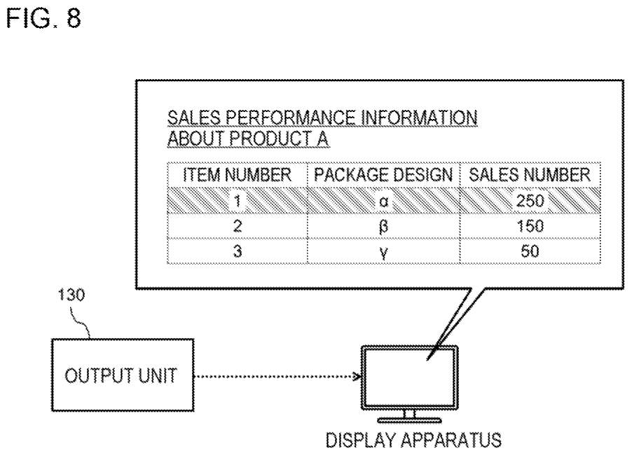

The output unit 130 outputs the sales performance by package design of a product being generated in the processing in 5204 to a display apparatus connected via the input/output interface 3050 or a display apparatus of a terminal (not illustrated) connected via the network interface 3060 (S206). For example, the output unit 130 outputs information as illustrated in FIG. 8 to a display apparatus.

FIG. 8 is a diagram illustrating one example of sales performance information by package design of a product being output from the output unit 130. A screen illustrated in FIG. 8 includes, for a specified product (product A), sales performance information indicating a sales number for each of three kinds of package designs (α, β, and γ). A salesclerk in charge of an ordering operation can recognize a package design having good sales of the specified product, based on the sales performance information as illustrated in FIG. 8. Then, when a salesclerk in charge of an ordering operation orders the product, product sales can be improved by increasing an ordering number of the package design having good sales.

Note that, as illustrated in FIG. 8, the output unit 130 may be configured in such a way as to display a package design having good sales or poor sales in a distinguishable state, based on an aggregate result by package design. For example, the output unit 130 may be configured in such a way as to emphasize and display a package design having a sales number equal to or more than a predetermined reference (and less than the predetermined reference) (diagonally shaded portion in FIG. 8). Further, for a display portion related to a package design having a sales number equal to or more than a predetermined reference (and less than the predetermined reference), the output unit 130 may change a size and a color of a character, or provide a specific mark.

### Second Example Embodiment

A sales management system 1 according to the present example embodiment has a configuration similar to that in the first example embodiment except for a point described below.

### Functional Configuration Example

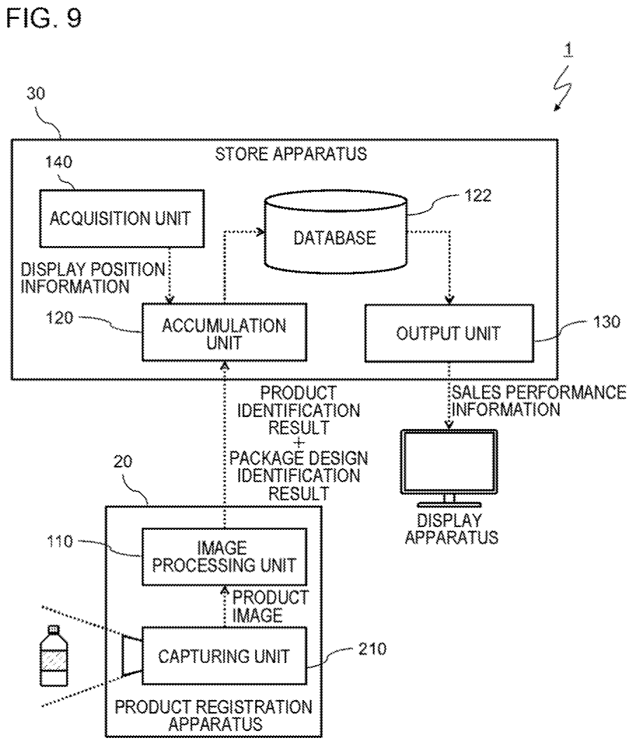

FIG. 9 is a diagram illustrating a functional configuration of the sales management system 1 according to a second example embodiment. As illustrated in FIG. 9, the sales management system 1 according to the present example embodiment is different from the sales management system 1 according to the first example embodiment illustrated in FIG. 2 in a point that the sales management system 1 according to the present example embodiment further includes an acquisition unit 140.

The acquisition unit 140 acquires display position information indicating a display position of a product to be purchased by a customer. Herein, the display position information may be information indicating a sales floor in a store, and may be information indicating a position in a product display shelf. An accumulation unit 120 according to the present example embodiment accumulates, in a database 122, display position information acquired by the acquisition unit 140 in association with an identification result of a product to be purchased by a customer and an identification result of a package design of the product.

### Flow of Processing

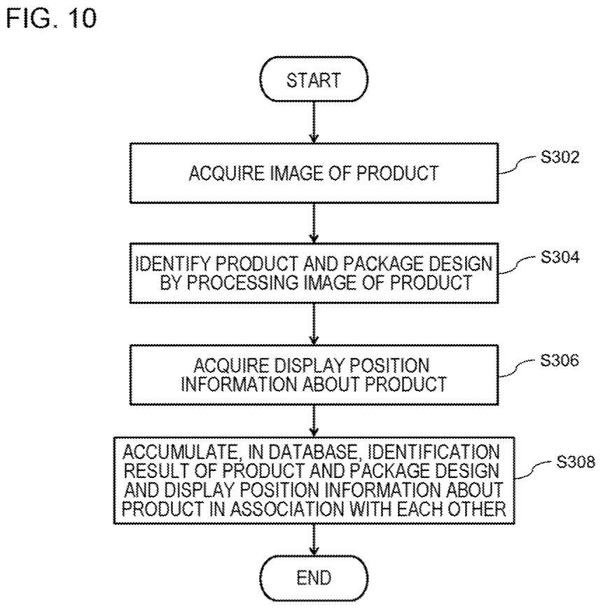

Hereinafter, a flow of processing performed by the sales management system 1 according to the present example embodiment will be described. FIG. 10 is a flowchart illustrating a flow of identification result accumulation processing performed by the sales management system 1 according to the second example embodiment.

First, an image processing unit 110 acquires an image of a product being generated by a capturing unit 210 (S302). Then, the image processing unit 110 identifies a product captured in the image and a package design of the product by processing the image being generated in the processing in S302 (S304).

Further, the acquisition unit 140 acquires display position information indicating a display position of a product captured in an image (S306). For example, it is assumed that a display position (shelf allocation) of a product is predetermined by package design. In this case, a table that stores a product position by package design is prepared. The acquisition unit 140 can acquire display position information about a product captured in an image from the table, based on an identification result of a package design by the image processing unit 110. Further, for example, it is assumed that a tag (radio frequency (RF) tag, and the like) having an individual tag ID being stored is provided to each product, and an individual product can be distinguished by a tag ID. In this case, by preparing, in advance, a table that stores a correspondence between a tag ID stored in a tag and display position information about a product, display position information about a product can be acquired based on a tag ID. In this case, the acquisition unit 140 can acquire, based on a tag ID being read from a tag by a not-illustrated tag reading apparatus, display position information about a product provided with the tag.

The accumulation unit 120 accumulates, in the database 122, a processing result (an identification result of a product and a package design) of an image by the image processing unit 110 and the display position information about the product being acquired by the acquisition unit 140 in association with each other (S308).

In the present example embodiment, an identification result of a product and a package design of the product, and information indicating a display place of the product are accumulated in association with each other in the database 122. A product analysis based on a display position of a product can be achieved by using the database 122 according to the present example embodiment. For example, a person who manages a store layout can conjecture, from information accumulated in the database 122, a correlation between sales performance by package design of a product and a display position of a product, and the like.

While the example embodiments of the present invention have been described above with reference to the drawings, the present invention should not be interpreted by being limited to the example embodiments, and various modifications, improvements, and the like can be made based on knowledge of a person skilled in the art without departing from the scope of the present invention. A plurality of components disclosed in the example embodiments can form various inventions by an appropriate combination. For example, some components may be deleted from all the components indicated in the example embodiments, and components in different example embodiments may be appropriately combined within an extent that there is no contradiction in context.

Further, the plurality of steps (processing) are described in order in the sequence diagram and the flowcharts used in the above-described description, but an execution order of steps performed in each of the example embodiments is not limited to the described order. In each of the example embodiments, an order of illustrated steps may be changed within an extent that there is no harm in context.

A part or the whole of the above-described example embodiment may also be described in supplementary notes below, which is not limited thereto.
1. A sales management system, including:

an image processing unit that identifies based on an image of a purchase product, the product and a package design of the product; and

an output unit that outputs sales performance information by package design of the product, based on a plurality of identification results of the product and the package design of the product.
2. The sales management system according to supplementary note 1, further including an accumulation unit that accumulates, in a database, an identification result of the product and the package design of the product.
3. The sales management system according to supplementary note 2, further including

an acquisition unit that acquires display position information indicating a display position of the product, wherein

the accumulation unit accumulates, in the database, the display position information and an identification result of the product and the package design of the product in association with each other.
4. The sales management system according to any one of supplementary notes 1 to 3, wherein

the image processing unit identifies the product and the package design of the product by verifying feature data acquired from the image with feature data for each package design of the product.
5. The sales management system according to supplementary note 4, further including a feature data storage unit that stores feature data for each package design of the product in association with identification information of the product.
6. The sales management system according to supplementary note 5, wherein the image processing unit narrows down data to be verified from feature data for each package design of the product by using identification information of the product.
7. A sales management method, including:

by a computer,

identifying, based on an image of a purchase product, the product and a package design of the product; and

outputting sales performance information by package design of the product, based on a plurality of identification results of the product and the package design of the product.
8. The sales management method according to supplementary note 7, further including, by the computer,

accumulating, in a database, an identification result of the product and the package design of the product.
9. The sales management method according to supplementary note 8, further including: by the computer,

acquiring display position information indicating a display position of the product; and

accumulating, in the database, the display position information and an identification result of the product and the package design of the product in association with each other. 10. The sales management method according to any one of supplementary notes 7 to 9, further including,

by the computer,

identifying the product and the package design of the product by verifying feature data acquired from the image with feature data for each package design of the product.
11. The sales management method according to supplementary note 10, further including, by the computer,

a feature data storage unit that stores feature data for each package design of the product in association with identification information of the product.
12. The sales management method according to supplementary note 11, further including, by the computer,

narrowing down data to be verified from feature data for each package design of the product by using identification information of the product.
13. A program for causing a computer to function as:

a unit that identifies, based on an image of a purchase product, the product and a package design of the product; and

a unit that outputs sales performance information by package design of the product, based on a plurality of identification results of the product and the package design of the product.
14. The program according to supplementary note 13 for further causing the computer to function as

a unit that accumulates, in a database, an identification result of the product and the package design of the product.
15. The program according to supplementary note 14 for further causing the computer to function as:

a unit that acquires display position information indicating a display position of the product; and

a unit that acquires, in the database, the display position information and an identification result of the product and the package design of the product in association with each other.

16. The program according to any one of supplementary notes 13 to 15 for further causing the computer to function as

a unit that identifies the product and the package design of the product by verifying feature data acquired from the image with feature data for each package design of the product.
17. The program according to supplementary note 16 for further causing the computer to function as

a feature data storage unit that stores feature data for each package design of the product in association with identification information of the product.
18. The program according to supplementary note 17 for further causing the computer to function as

a unit that narrows down data to be verified from feature data for each package design of the product by using identification information of the product.
19. A store apparatus, including:

an acquisition unit that acquires an identification result of a product and a package design of the product; and

an output unit that outputs sales performance information by package design of the product, based on an identification result of the product and the package design of the product.

What is claimed is:

1. A sales management system, comprising:
a memory storing instructions; and
a processor configured to execute the instructions to:
identify, based on an image of a purchase product, the product and a package design of the product; and
output sales performance information by package design of the product, based on an identification result of the product and the package design of the product.

2. The sales management system according to claim 1, wherein
the processor is further configured to execute the instructions to accumulate, in a database, an identification result of the product and the package design of the product.

3. The sales management system according to claim 2, wherein the processor is further configured to execute the instructions to:
acquire display position information indicating a display position of the product; and
accumulate, in the database, the display position information and an identification result of the product and the package design of the product in association with each other.

4. The sales management system according to claim 1 wherein
the processor is further configured to execute the instructions to identify the product and the package design of the product by verifying feature data acquired from the image with feature data for each package design of the product.

5. The sales management system according to claim 4, further wherein
the processor is further configured to execute the instructions to store feature data for each package design of the product in association with identification information of the product.

6. The sales management system according to claim 5, wherein
the processor is further configured to execute the instructions to narrow down data to be verified from feature data for each package design of the product by using identification information of the product.

7. A sales management method, comprising:
by a computer,
identifying, based on an image of a purchase product, the product and a package design of the product; and
outputting sales performance information by package design of the product, based on an identification result of the product and the package design of the product.

8. (canceled)

9. A store apparatus, comprising:
a memory storing instructions; and
a processor configured to execute the instructions to:
acquire an identification result of a product and a package design of the product; and
output sales performance information by package design of the product, based on an identification result of the product and the package design of the product.
